(19) United States
(12) Patent Application Publication
(10) Pub. No.: US 2024/0049355 A1
(43) Pub. Date: Feb. 8, 2024

(54) METHOD AND APPARATUS FOR OPERATION PARAMETER UPDATE FOR EPCS

(71) Applicant: Samsung Electronics Co., Ltd., Suwon-si (KR)

(72) Inventors: Peshal Nayak, Plano, TX (US); Vishnu Vardhan Ratnam, Plano, TX (US); Rubayet Shafin, Allen, TX (US); Boon Loong Ng, Plano, TX (US)

(21) Appl. No.: 18/361,675

(22) Filed: Jul. 28, 2023

Related U.S. Application Data
(60) Provisional application No. 63/395,572, filed on Aug. 5, 2022.
(60) Provisional application No. 63/417,891, filed on Oct. 20, 2022.
(60) Provisional application No. 63/468,728, filed on May 24, 2023.

(51) Int. Cl. H04W 76/50; H04W 76/15

(52) U.S. Cl. CPC H04W 76/50; H04W 76/15

(57) ABSTRACT

Methods and apparatuses for an operation parameter update for emergency preparedness communication services (EPCS) operation are disclosed. A method for wireless communication performed by an access point (AP) multi-link device (MLD) that includes APs, the method comprising: forming a link with a corresponding station (STA) of a non-AP MLD; transmitting information associated with emergency preparedness communication services (EPCS) operation parameters to the corresponding STA; determining whether the EPCS operation parameters transmitted to the corresponding STA need to be updated; when the EPCS operation parameters transmitted to the corresponding STA do not need to be updated, continuing with current EPCS operation parameters; and when the EPCS operation parameters transmitted to the corresponding STA need to be updated, determining a procedure for updating the EPCS operation parameters.

### CROSS-REFERENCE TO RELATED APPLICATION AND CLAIM OF PRIORITY

This application claims priority under 35 U.S.C. § 119(e) to U.S. Provisional Patent Application No. 63/395,572 filed on Aug. 5, 2022; U.S. Provisional Patent Application No. 63/417,891 filed on Oct. 20, 2022; and U.S. Provisional Patent Application No. 63/468,728 filed on May 24, 2023; which are hereby incorporated by reference in their entireties.

### TECHNICAL FIELD

This disclosure relates generally to transmission efficiency in wireless communications systems that include multi-link devices. Embodiments of this disclosure relate to methods and apparatuses for an operation parameter update for emergency preparedness communication services (EPCS) operation.

### BACKGROUND

Wireless local area network (WLAN) technology allows devices to access the internet in the 2.4 GHz, 5 GHz, 6 GHz, or 60 GHz frequency bands. WLANs are based on the Institute of Electrical and Electronic Engineers (IEEE) 802.11 standards. The IEEE 802.11 family of standards aims to increase speed and reliability and to extend the operating range of wireless networks.

Multi-link operation (MLO) is a feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-access point (AP) multi-link device (MLD) to discover, authenticate, associate, and set up multiple links with an AP MLD. Channel access and frame exchange is possible on each link between the AP MLD and non-AP MLD.

### SUMMARY

Embodiments of the present disclosure provide methods and apparatuses for operation parameter update for EPCS operation.

In one embodiment, an access point (AP) multi-link device (MLD) comprises: APs, each comprising a transceiver configured to: form a link with a corresponding station (STA) of a non-AP MLD; and transmit information associated with emergency preparedness communication services (EPCS) operation parameters to the corresponding STA. The AP-MLD further comprises a processor operably coupled to the transceiver, the processor configured to: determine whether the EPCS operation parameters transmitted to the corresponding STA need to be updated; when the EPCS operation parameters transmitted to the corresponding STA do not need to be updated, continue with current EPCS operation parameters; and when the EPCS operation parameters transmitted to the corresponding STA need to be updated, determine a procedure for updating the EPCS operation parameters.

In another embodiment, a non-AP MLD comprises: STAs, each comprising a transceiver configured to: form a link with a corresponding AP of an AP MLD; and receive information associated with EPCS operation parameters from the corresponding AP. The non-AP MLD further comprises a processor operably coupled to the transceiver, the processor configured to: determine whether the EPCS operation parameters received from the corresponding AP need to be updated; when the EPCS operation parameters received from the corresponding AP do not need to be updated, continue with current EPCS operation parameters; and when the EPCS operation parameters received from the corresponding AP need to be updated, determine a procedure for updating the EPCS operation parameters.

In yet another embodiment, a method for wireless communication performed by an AP-MLD that includes APs, the method comprising: forming a link with a corresponding STA of a non-AP MLD; transmitting information associated with EPCS operation parameters to the corresponding STA; determining whether the EPCS operation parameters transmitted to the corresponding STA need to be updated; when the EPCS operation parameters transmitted to the corresponding STA do not need to be updated, continuing with current EPCS operation parameters; and when the EPCS operation parameters transmitted to the corresponding STA need to be updated, determining a procedure for updating the EPCS operation parameters.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP according to embodiments of the present disclosure;

FIG. 2B illustrates an example STA according to embodiments of the present disclosure;

FIG. 3 illustrates an example scenario involving EPCS authorized devices co-existing with non-EPCS devices according to embodiments of the present disclosure;

FIG. 4 illustrates an example method for explicit teardown and re-setup for EPCS operation according to embodiments of the present disclosure;

FIG. 5 illustrates an example method performed by an AP for implicit teardown and EPCS re-setup according to embodiments of the present disclosure;

FIG. 6 illustrates an example method performed by an STA for implicit teardown and EPCS re-setup according to embodiments of the present disclosure;

FIG. 7 illustrates an example method performed by an AP for transmission of an unsolicited update frame according to embodiments of the present disclosure;

FIG. 8 illustrates an example method performed by an STA for handling of an unsolicited update frame according to embodiments of the present disclosure;

FIG. 9 illustrates an example method for a management frame based EPCS operation parameter update according to embodiments of the present disclosure;

FIG. 10 illustrates an example method performed by an AP for degrading a normal operation parameter set according to embodiments of the present disclosure; and

FIG. 11 illustrates an example of a method for wireless communication performed by an AP device according to embodiments of the present disclosure.

### DETAILED DESCRIPTION

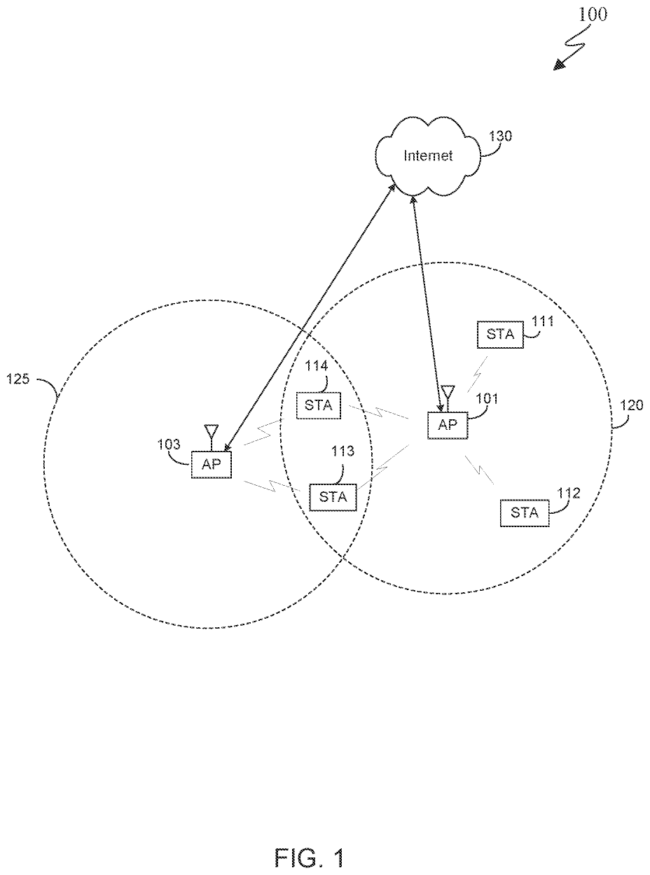

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D2.0, 2022.

Embodiments of the present disclosure provide mechanisms for an operation parameter update for EPCS operation.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for traffic urgency indication. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

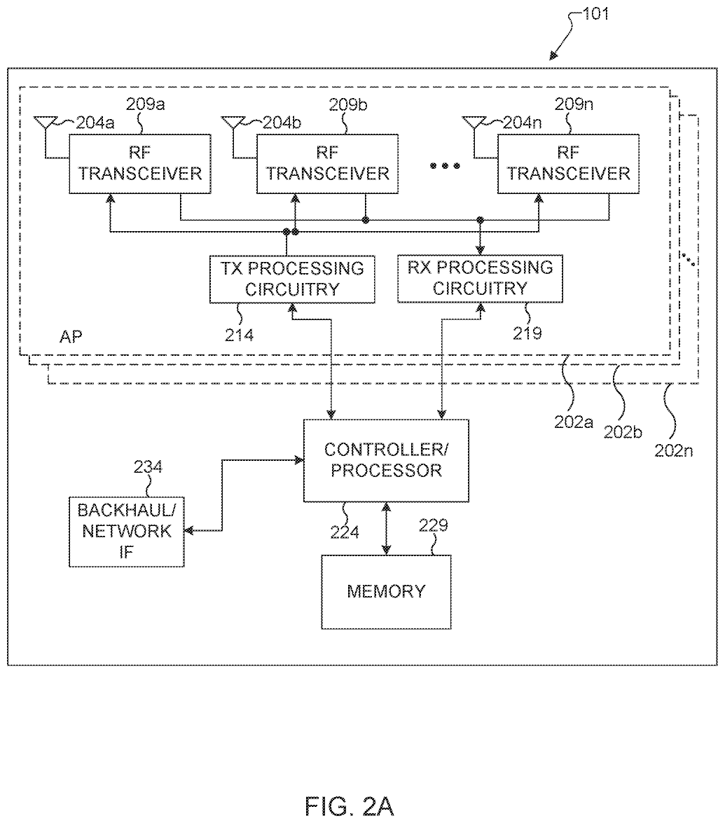

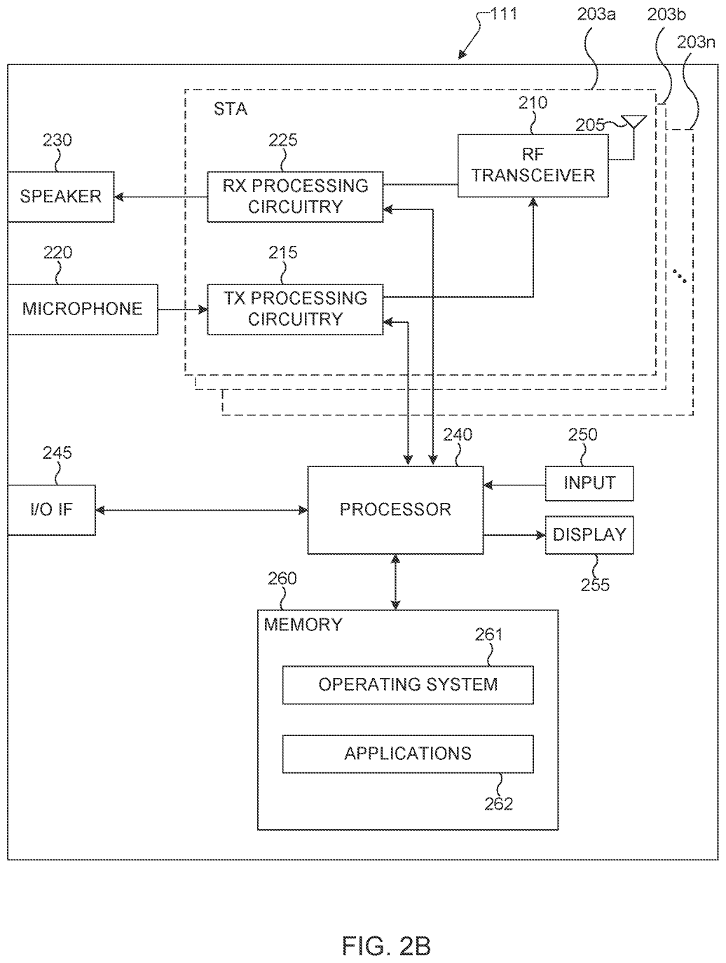

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including an operation parameter update for EPCS operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for an operation parameter update for EPCS operation. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to support an operation parameter update for EPCS operation. In some embodiments, the controller/processor 240 includes at least one microprocessor or microcontroller.

The controller/processor 240 is also capable of executing other processes and programs resident in the memory 260, such as operations for supporting an operation parameter update for EPCS operation. The controller/processor 240 can move data into or out of the memory 260 as required by an executing process. In some embodiments, the controller/processor 240 is configured to execute a plurality of applications 262, such as applications for supporting operation parameter update for EPCS operation. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Emergency telecommunication services have been implemented in a number of countries with the objective of providing prioritized access in the times of disasters or emergencies. Examples of such telecommunication services in the United States include government emergency telecommunication service (GETS), wireless priority service (WPS), next generation network priority services (NGN priority services), telecommunications service priority (TSP), etc. Such services have also been implemented in other countries. Examples of such services include blue light mobile service in Belgium, mobile telecommunications privileged access scheme in Great Britain, disaster priority telephone in Japan, etc. Typically, such services are subscription based, operator controlled, enabled through global standards and are offered over commercial network infrastructure.

In recent times there has been a growing need for such services over Wi-Fi networks. In IEEE 802.11be, Emergency preparedness communication services (EPCS) has been introduced with the goal of providing prioritized access to certain authorized users. As a part of this service, the user that has associated with an AP can be authorized by the AP to take advantage of EPCS service. Once authorized, the user can use an enhanced EDCA parameter set with values for parameters such as CWmin[AC], CWmax[AC], AIFSN[AC], TXOP[AC], etc. which are different from those for other STAs associated with the same AP. With this enhanced EDCA parameter set, the non-AP MLD that is authorized by the AP, benefits from prioritized access as it can capture the channel faster compared to other users in the network. After EPCS is disabled, the non-AP MLD can update its EDCA parameter set to match that of other non-EPCS users in the network.

Various embodiments of the present disclosure recognize that after setup of EPCS, when a non-AP MLD is using the EPCS priority access feature, the network and traffic conditions can change. Further, the number of associated non-EPCS devices can also increase. As a result, the originally provided EDCA parameter set to the non-AP MLD may no longer provide it the same level of priority access that it was when EPCS priority access was setup.

Accordingly, various embodiments of the present disclosure provide mechanisms for enabling an AP MLD/AP to change or update the EPCS operation parameters for EPCS devices in the network.

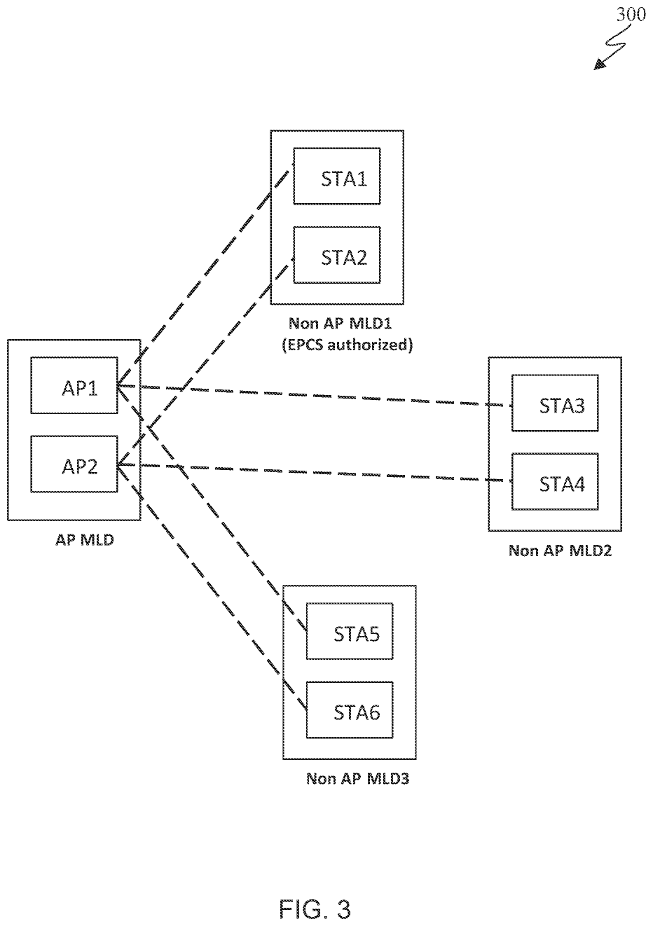

FIG. 3 illustrates an example scenario 300 involving EPCS authorized devices co-existing with non-EPCS devices according to embodiments of the present disclosure. The embodiment of the example scenario 300 involving EPCS authorized devices co-existing with non-EPCS devices shown in FIG. 3 is for illustration only. Other embodiments of the example scenario 300 involving EPCS authorized devices co-existing with non-EPCS devices could be used without departing from the scope of this disclosure.

Consider a scenario as depicted in FIG. 3. An AP MLD with affiliated APs-AP 1 and AP 2 has multiple non-AP MLDs associated with it. The non-AP MLDs are denoted as non-AP MLD1, non-AP MLD2 and non-AP MLD3. Non-AP MLD1 is EPCS authorized and has EPCS priority access enabled. Further, as per the EPCS priority access setup procedure in the IEEE P802.11 specification, non-AP MLD1 has been provided with an enhanced EDCA parameter set by AP MLD1 during the setup process. This enhanced EDCA parameter set provides EPCS authorized non-AP MLD1 a higher priority over other non-EPCS devices in the network (by providing it a higher probability of acquiring channel during channel access).

After setup of EPCS when non-AP MLD1 is using the EPCS priority access feature, the network and traffic conditions can change. Further, the number of associated non-EPCS devices can also increase. As a result, the originally provided EDCA parameter set to non-AP MLD1 may no longer provide it the same level of priority access that it was when EPCS priority access was setup. Consequently, the AP MLD may want to change the EPCS operation parameters for EPCS authorized devices.

As used in the present disclosure, the term device can be interpreted as referring to a non-AP MLD or a non-AP STA (when there is no MLO operation). It can also refer to non-AP STAs affiliated with a non-AP MLD.

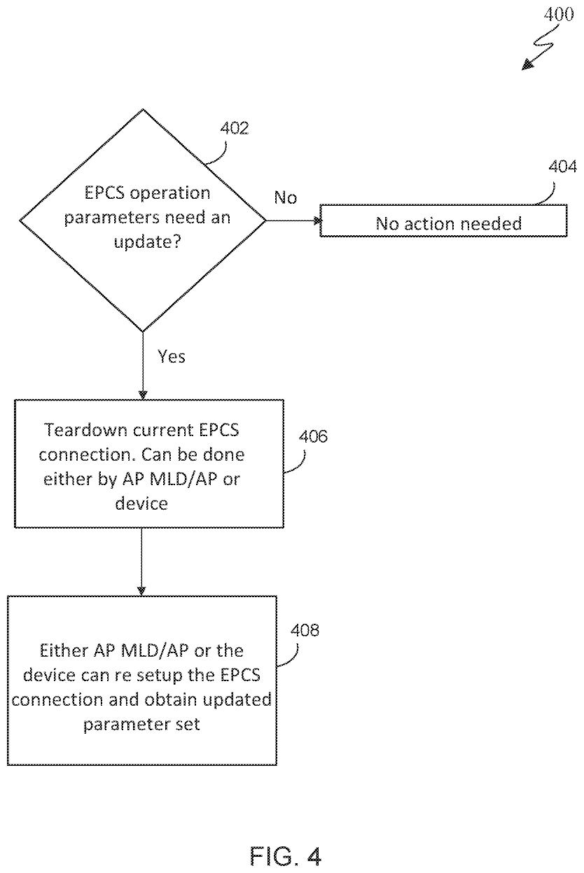

FIG. 4 illustrates an example method 400 for explicit teardown and re-setup for EPCS operation according to embodiments of the present disclosure. The embodiment of the example method 400 for explicit teardown and re-setup for EPCS operation shown in FIG. 4 is for illustration only. Other embodiments of the example method 400 for explicit teardown and re-setup for EPCS operation could be used without departing from the scope of this disclosure.

As illustrated in FIG. 4, the method 400 begins at step 402, where a determination is made whether EPCS operation parameters need an update. If the EPCS operation parameters do not need an update, then at step 404, no action is needed. If the EPCS operation parameters need an update, then at step 406, the current EPCS connection is torn down. The teardown can be done by either the AP MLD/AP or by the device. At step 408, either the AP MLD/AP or the device can re-setup the EPCS connection and obtain an updated parameter set.

In one embodiment, when the AP MLD detects that the EPCS operation parameters (e.g., enhanced EDCA parameter set for EPCS priority access) provided to EPCS authorized devices no longer provide them with the same level of priority access that they used to after EPCS was setup, the AP can send a frame to tear down the EPCS priority access for the EPCS devices associated with it (e.g., EPCS priority access teardown frame). The teardown frame can contain a reason code to inform the EPCS device that the reason for teardown is because the originally provided EPCS operation parameters need to be updated. After this step, either the AP MLD or the EPCS device can re-setup EPCS priority access and acquire the new updated EPCS operation parameters.

In another embodiment, when the non-AP MLD detects that the EPCS operation parameters are providing it with the same level of priority access that they used to after EPCS was setup, the EPCS device can send a frame to tear down the EPCS priority access with a reason code to inform the AP MLD that the reason for teardown is because the originally provided EPCS operation parameters need to be updated. This tear down and re-setup operations can be performed on any of the links setup between the AP MLD and the EPCS device.

According to another embodiment, AP MLD can maintain updated EPCS operation parameters. Thus, whenever a non-AP MLD tears down and performs re-setup, it can obtain updated EPCS operation parameters.

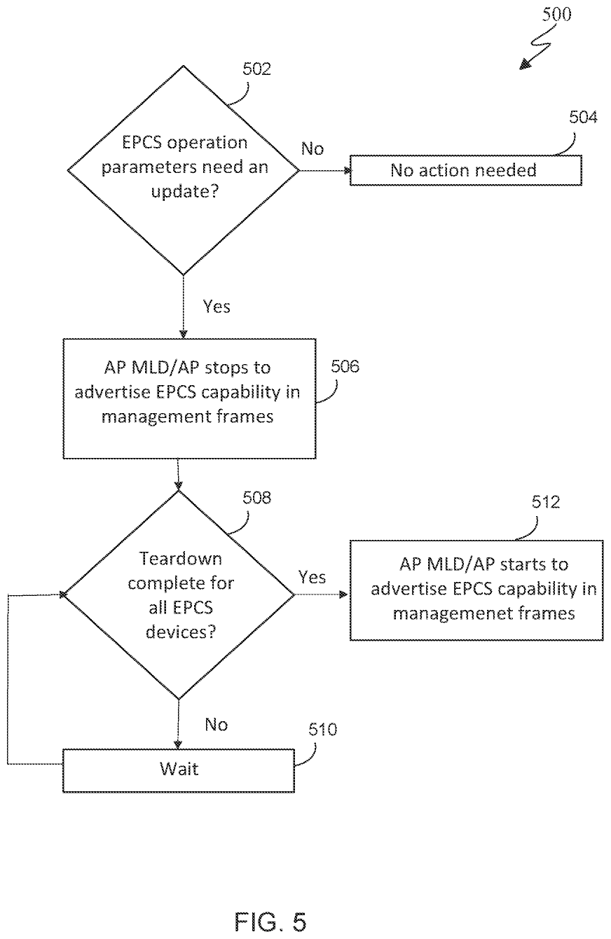

FIG. 5 illustrates an example method 500 performed by an AP for implicit teardown and EPCS re-setup according to embodiments of the present disclosure. The embodiment of the example method 500 performed by an AP for implicit teardown and EPCS re-setup shown in FIG. 5 is for illustration only. Other embodiments of the example method 500 performed by an AP for implicit teardown and EPCS re-setup could be used without departing from the scope of this disclosure.

As illustrated in FIG. 5, the method 500 begins at step 502, where a determination is made whether EPCS operation parameters need an update. If the EPCS operation parameters do not need an update, then at step 504, no action is needed. If the EPCS operation parameters need an update, then at step 506, the AP MLD/AP stops to advertise EPCS capability in management frames. At step 508, a determination is made whether teardown is complete for all EPCS devices. If teardown is not complete for all EPCS devices, then at step 510, the method waits for teardown completion. If teardown is complete for all EPCS devices, then at step 512, the AP MLD/AP starts to advertise EPCS capability in management frames.

In one embodiment, the AP MLD can stop advertising its EPCS capability in management frames (e.g., beacon and probe response frames). Upon receiving a management frame that no longer shows the EPCS capability indication for the AP and if this management frame was previously showing the capability, then the EPCS devices associated with the AP can set their EPCS state to torn down within a time duration (e.g., within the beacon interval) as shown in FIG. 5.

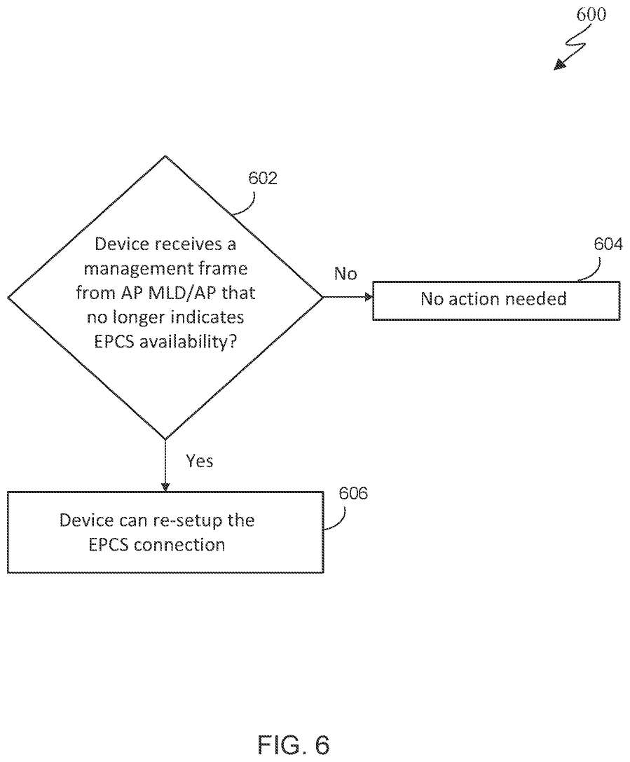

FIG. 6 illustrates an example method 600 performed by an STA for implicit teardown and EPCS re-setup according to embodiments of the present disclosure. The embodiment of the example method 600 performed by an STA for implicit teardown and EPCS re-setup shown in FIG. 6 is for illustration only. Other embodiments of the example method 600 performed by an STA for implicit teardown and EPCS re-setup could be used without departing from the scope of this disclosure.

As illustrated in FIG. 6, the method 600 begins at step 602, where a determination is made whether a device receives a management frame from the AP MLD/AP that no longer indicates EPCS capability. If the device does not receive a management frame from the AP MLD/AP that no longer indicates EPCS capability, then at step 604, no action is needed. If the device receives a management frame from the AP MLD/AP that no longer indicates EPCS capability, then at step 606, the device can re-setup the EPCS connection.

The AP MLD can again start to advertise its EPCS capability in management frames. If an EPCS capable device receives a management frame that now shows the capability with the associated AP MLD, it can re-setup its EPCS connection with the AP MLD as shown in FIG. 6. During this re-setup, AP MLD can provide the updated EPCS operation parameters (e.g., the enhanced EDCA parameter set) to the device upon authorization.

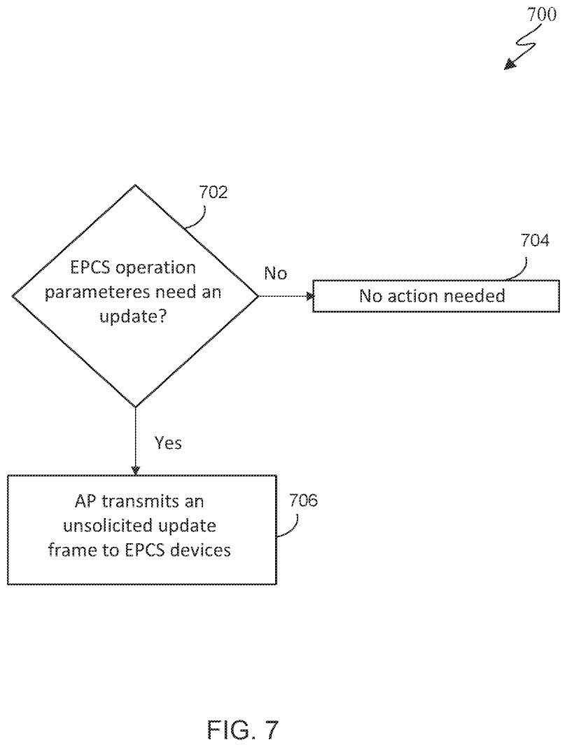

FIG. 7 illustrates an example method 700 performed by an AP for transmission of an unsolicited update frame according to embodiments of the present disclosure. The embodiment of the example method 700 performed by an AP for transmission of an unsolicited update frame shown in FIG. 7 is for illustration only. Other embodiments of the example method 700 performed by an AP for transmission of an unsolicited update frame could be used without departing from the scope of this disclosure.

As illustrated in FIG. 7, the method 700 begins at step 702, where a determination is made whether EPCS operation parameters need an update. If the EPCS operation parameters do not need an update, then at step 704, no action is needed. If the EPCS operation parameters need an update, then at step 706, the AP transmits an unsolicited update frame to EPCS devices.

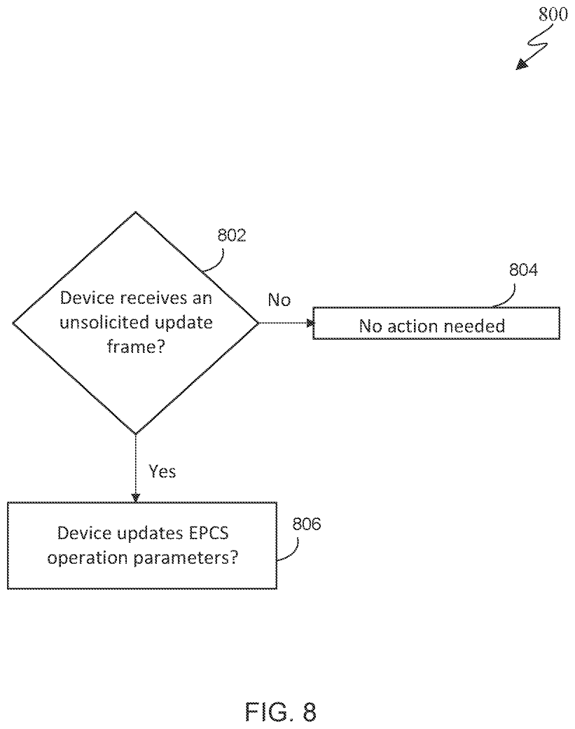

FIG. 8 illustrates an example method 800 performed by an STA for transmission of an unsolicited update frame according to embodiments of the present disclosure. The embodiment of the example method 800 performed by an STA for transmission of an unsolicited update frame shown in FIG. 8 is for illustration only. Other embodiments of the example method 800 performed by an STA for transmission of an unsolicited update frame could be used without departing from the scope of this disclosure.

As illustrated in FIG. 8, the method 800 begins at step 802, where a determination is made whether a device receives an unsolicited update frame. If the device does not receive an unsolicited update frame, then at step 804, no action is needed. If the device receives an unsolicited update frame, then at step 806, the device updates EPCS operation parameters.

In one embodiment, an AP MLD can send an unsolicited frame to the EPCS devices and provide them with updated EPCS operation parameters (e.g., enhanced EDCA parameter set for EPCS priority access). Another example can be the MU EDCA parameters.

According to one embodiment, the unsolicited frame can contain one or more of the information fields indicated in Table 1.

TABLE 1
Information fields present in the unsolicited frame transmitted by the AP MLD to the
EPCS associated devices for updating EPCS operation parameters

| Information field | Description |
|---|---|
| Reason code | A reason code stating the reason for sending the frame (e.g., |
| | EPCS operation parameter update). |
| Category | Action field category definition (e.g., EHT) |
| Protected EHT Action | Defining the type of action that is being requested (e.g., EPCS |
| | priority access enable request) |
| Dialog Token | A token for matching the action responses with the action |
| | requests. |
| Updated EPCS operation | Updated EPCS operation parameters (e.g., EDCA parameter set). |
| parameters | This field can also contain EPCS operation parameters for each of |
| | the link setup between the AP and the EPCS authorized device. |
| Priority access multi-link | A priority access multi-link element that carries the updated EPCS |
| element | operation parameters (e.g., EDCA parameter set, MU EDCA |
| | parameters set). |

The above information can also be transmitted by the AP in any of the frames defined in the standard (e.g., the EPCS priority access enable request frame, the EPCS priority access enable response frame, etc.).

Upon receiving the above frame from the AP, the EPCS device can update the EPCS operation parameters and continue its operation with these updated parameters. Specifically, the EPCS device (e.g., each non-AP STA affiliated with an EPCS non-AP MLD) can update its dot11EDCATable to the values indicated in the frame transmitted by the AP MLD/AP corresponding to its own link as indicated, for instance, by a link ID. The EPCS device (e.g., each non-AP STA affiliated with an EPCS non-AP MLD) can update its dot11MUEDCATable to the values indicated in the frame transmitted by the AP MLD/AP corresponding to its own link as indicated, for instance, by a link ID. The update can either be done immediately or as soon as possible/practical in implementation.

According to one embodiment, the frame can carry a priority access multi-link element with a per-STA profile with an EDCA Parameters Set element containing the updated EDCA and MU EDCA parameters for each set up link.

The above frame can be transmitted in a unicast, group cast or broadcast manner. When the update is done in a broadcast manner, the frame transmitted by the AP MLD/AP to the EPCS enabled non-AP MLDs can be called a broadcast EPCS Priority Access Enable Request frame (and similarly broadcast EPCS Priority Access enable response frame, broadcast EPCS Priority Access Teardown frame, etc.) and can contain updated EDCA parameters in the Priority Access Multi-link element. Further, according to this embodiment, when the AP MLD/AP transmits broadcast EPCS Priority Access Enable Request frame, it can set the PeerSTAAddress to the broadcast address.

In another embodiment, the AP can transmit one or more of the information fields shown in Table 2, in any of the management frames (e.g., Beacon frame). Thus, when the AP detects a need for updating the EPCS operation parameters, it can do so and then send the updated EPCS operation parameters in the management frames.

TABLE 2
Information transmitted in management frames for EPCS operation

| Information field | Description |
|---|---|
| Normal operation | Parameter set (e.g., EDCA parameter set) that is used by |
| parameter set | normal devices. In one embodiment this parameter set can be |
| | provided on a per link basis. Thus, each link can have a |
| | normal operation parameter set. |
| Normal operation | Indication that the parameter set indicated by the above field is |
| parameter set indicator | for normal operation. E.g., this can be done by using a bit that |
| | is set to a particular value (e.g., 1) to indicate that the |
| | parameter set is the normal operation parameter set. |
| EPCS operation parameter | Parameter set (e.g., enhanced EDCA parameter set) that is |
| set | used by EPCS authorized devices. In one embodiment this |
| | parameter set can be provided on a per link basis. Thus, each |
| | link can have a EPCS operation parameter set. |
| EPCS operation parameter | Indication that the parameter set indicated by the above field is |
| set indicator | for EPCS operation. E.g., this can be done by using a bit that is |
| | set to a particular value (e.g., 1) to indicate that the parameter |
| | set is the EPCS operation parameter set. |
| Update time | The time after which the update needs to be applied by the |
| | EPCS devices. |

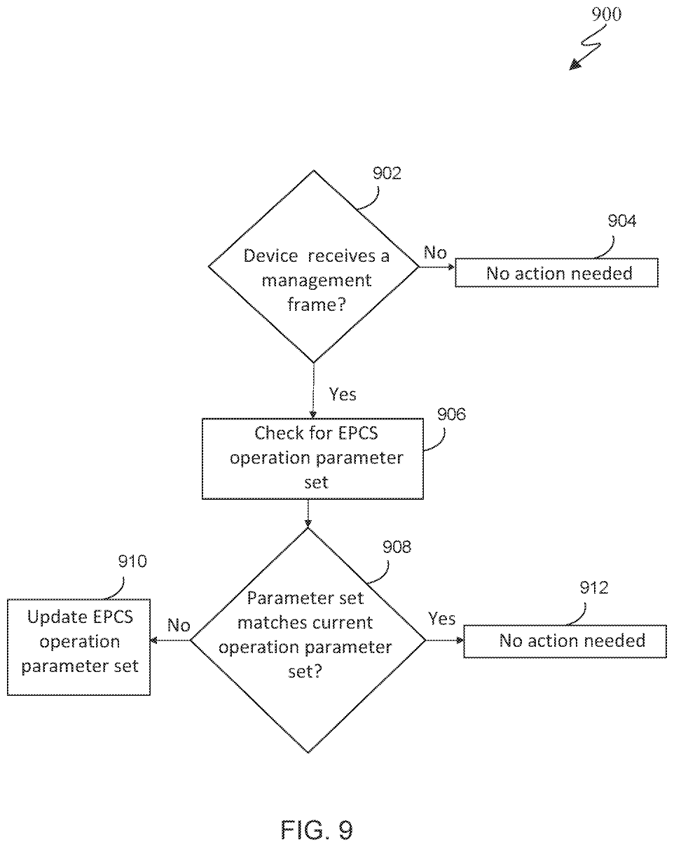

FIG. 9 illustrates an example method 900 for a management frame based EPCS operation parameter update according to embodiments of the present disclosure. The embodiment of the example method 900 for a management frame based EPCS operation parameter update shown in FIG. 9 is for illustration only. Other embodiments of the example method 900 for a management frame based EPCS operation parameter update could be used without departing from the scope of this disclosure.

As illustrated in FIG. 9, the method 900 begins at step 902, where a determination is made whether a device receives a management frame. If the device does not receive a management frame, then at step 904, no action is necessary. If the device receives a management frame, then at step 906, a check for an EPCS parameter set is performed. At step 908, a determination is made whether the parameter set matches a current operation parameter set. If the parameter set matches a current operation parameter set, then at step 910, no action is needed. If the parameter set does not match the current operation parameter set, then at step 912, the EPCS operation parameter set is updated.

When an EPCS device receives a management frame with an EPCS operation parameter set that does not match the one it is currently using, the EPCS device can update the EPCS operation parameter set and can start to use the new one. In one embodiment, this update can be instantaneous after receiving the frame. In another embodiment, the AP MLD can provide the time after which the update needs to be applied. Thus, the EPCS device can apply the update after the specified time.

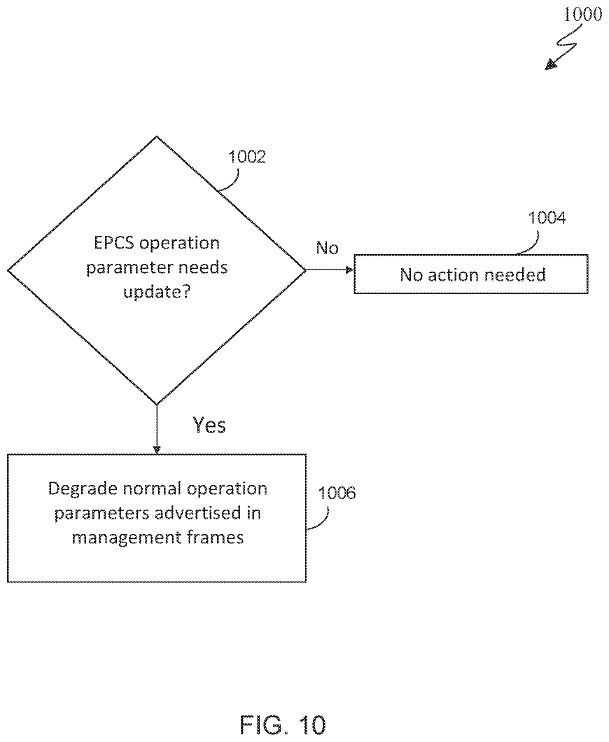

FIG. 10 illustrates an example method 1000 performed by an AP for degrading a normal operation parameter set according to embodiments of the present disclosure. The embodiment of the example method 1000 performed by an AP for degrading a normal operation parameter set shown in FIG. 10 is for illustration only. Other embodiments of the example method 1000 performed by an AP for degrading a normal operation parameter set could be used without departing from the scope of this disclosure.

As illustrated in FIG. 10, the method 1000 begins at step 1002, where a determination is made whether an EPCS operation parameter needs an update. If the EPCS operation parameter does not need an update, then at step 1004, no action is needed. If the EPCS operation parameter needs an update, then at step 1006, normal operation parameters advertised in management frames are degraded.

In one embodiment, the AP MLD can advertise the normal operation parameter set (e.g., EDCA parameter set) in management frames (e.g., beacons). Further, according to this embodiment, when the AP detects that the assigned EPCS parameter set does not meet the priority requirements that it was originally intended to, the AP can modify the normal operation parameter set in a manner that the EPCS parameter set will continue to provide the same/similar level of priority that it was originally providing. Thus, the STAs with EPCS priority access enabled can obtain higher priority over those that do not have EPCS priority access enabled. For instance, the AP can degrade the EDCA parameter set for normal operation parameter. The AP can advertise this new normal operation parameter set in management frames and non-EPCS devices can use this new parameter set as depicted in FIG. 10. Thus, EPCS devices can continue to maintain their priority level. After some time (e.g., network/traffic conditions change again), when the AP determines that the original normal operation parameter set can be used again, it can transmit the original operation parameter set to the non-EPCS devices.

In one embodiment, the AP MLD can maintain the performance of EPCS devices by only degrading and upgrading the normal operation parameter set for non-EPCS devices.

In another embodiment, the AP MLD can use this degradation as a temporary solution to keep the performance while the AP upgrades the EPCS operation parameters of the EPCS authorized devices. According to this embodiment, once the AP degrades the performance of other devices, it can tear down and re-setup the EPCS connection for each EPCS device (as indicated in “1. Teardown and re-setup the connection”, “2. Implicit teardown and EPCS re-setup” or update the EPCS operation parameter set (as indicated in “3. Unsolicited update frame”). Thus, the EPCS operation parameters of each EPCS device can get updated. Following this update, the AP MLD can again reset the normal operation parameter set in management frames and non-EPCS devices can use that set again.

In one embodiment, the AP can broadcast a frame containing one or more of the information fields indicated in Table 3 below.

TABLE 3
Information transmitted broadcast teardown notification frame

| Information field | Description |
|---|---|
| Reason code | A reason code stating the reason for sending the |
| | frame (e.g., EPCS operation parameter update). |
| Category | Action field category definition (e.g., EHT) |
| Protected EHT | Defining the type of action that is being requested |
| Action | (e.g., EPCS priority access teardown) |
| Dialog Token | A token for matching the action responses with the |
| | action requests. |

Upon receiving the above frame, either the EPCS devices can re-setup their EPCS priority access again and thus receive an updated EPCS operation parameter set or the AP can send an unsolicited frame resetting up the EPCS connection for the EPCS devices (e.g., an unsolicited EPCS priority access enable request frame or response frame).

The above update can also be performed in a unicast, group cast or broadcast manner.

In one embodiment, the AP MLD can transmit a broadcast action frame with updated EPCS operation parameters (e.g., EDCA parameter set) on each of the links that are setup between the EPCS device and the AP MLD. Upon receiving the broadcast action frame, each EPCS device can update their EPCS operation parameters.

Instead of providing one EPCS operation parameter set (e.g., EDCA parameter set), the AP MLD can provide multiple EPCS operation parameter set to a device during EPCS authorization procedure. Further, according to this embodiment, the AP can advertise which EPCS operation parameter set that it currently uses in frames that it transmits to the EPCS devices or in broadcast frames (e.g., management frames). Thus, the EPCS authorized devices can update the EPCS operation parameter set based on this indication.

For any of the above procedures, the update can be done in a unicast, group cast or broadcast manner.

The above embodiments can also be used when the AP and/or the associated EPCS device are not MLDs.

Further, the information indicated in the above embodiments can either be provided on a device level or on a link level.

Further, the information indicated in the above embodiments can be transmitted in any of the existing frames in the specification.

The EPCS operation parameters set can either be EDCA parameters set or the MU EDCA parameters set.

The above embodiments can also apply to non-EPCS features such as R-TWT for providing priority access to other types of traffic. For example, latency sensitive or low latency traffic.

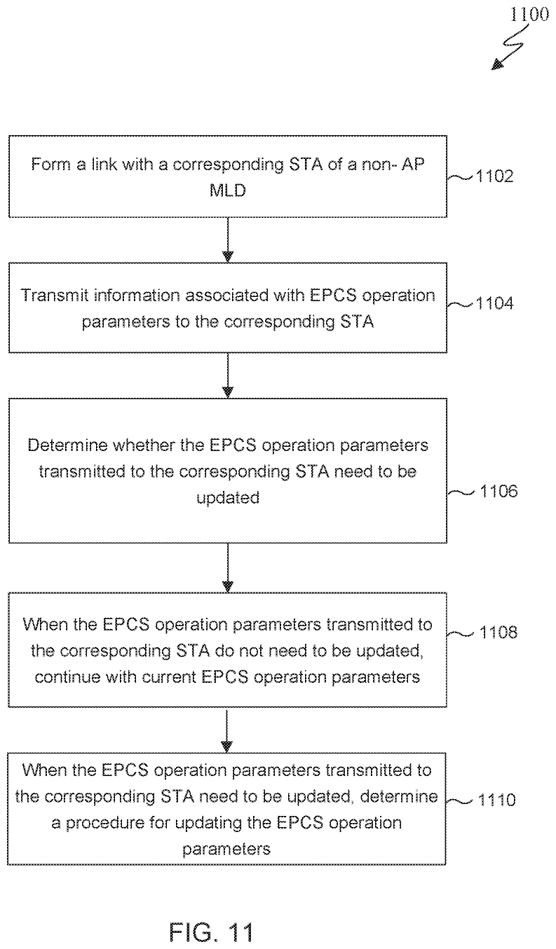

FIG. 11 illustrates a flowchart of a method 1100 for wireless communication performed by an AP-MLD that includes APs. The embodiment of the method 1100 for wireless communication performed by an AP-MLD shown in FIG. 11 is for illustration only. Other embodiments of the method 1100 for wireless communication performed by an AP-MLD could be used without departing from the scope of this disclosure.

As illustrated in FIG. 11, the method 1100 begins at step 1102, where the non-AP MLD forms a link with a corresponding STA of a non-AP MLD. At step 1104, the non-AP MLD transmits information associated with EPCS operation parameters to the corresponding STA. At step 1106, the non-AP MLD determines whether the EPCS operation parameters transmitted to the corresponding STA need to be updated. At step 1108, when the EPCS operation parameters transmitted to the corresponding STA do not need to be updated, the non-AP MLD continues with current EPCS operation parameters. At step 1110, when the EPCS operation parameters transmitted to the corresponding STA need to be updated, the non-AP MLD determines a procedure for updating the EPCS operation parameters.

In one embodiment, the EPCS operation parameters transmitted to the corresponding STA need to be updated, and the non-AP MLD generates a teardown message for tearing down the EPCS operation parameters for the corresponding STA, determines that the EPCS operation parameters have been torn down, and sets up updated EPCS operation parameters with the corresponding STA.

In one embodiment, the EPCS operation parameters transmitted to the corresponding STA need to be updated, and the non-AP MLD receives a teardown message from the corresponding STA for tearing down the EPCS operation parameters for the corresponding STA, determines that the EPCS operation parameters have been torn down, and sets up updated EPCS operation parameters with the corresponding STA.

In one embodiment, the EPCS operation parameters transmitted to the corresponding STA need to be updated, and the non-AP MLD generates a first management frame indicating that the AP MLD no longer has EPCS capability, determines that the EPCS operation parameters have been torn down, generates a second management frame indicating that the AP MLD again has EPCS capability, and sets up updated EPCS operation parameters with the corresponding STA.

In one embodiment, the EPCS operation parameters transmitted to the corresponding STA need to be updated, and the non-AP MLD generates a message for updating the EPCS operation parameters of the corresponding STA, and transmits, unsolicited, the message for updating the EPCS operation parameters.

In one embodiment, the message for updating the EPCS operation parameters comprises a frame that includes an action field.

In one embodiment, the message for updating the EPCS operation parameters comprises a frame that includes a priority access multi-link element.

In one embodiment, the message for updating the EPCS operation parameters comprises an EPCS priority access enable response frame that includes updated values of the EPCS operation parameters.

In one embodiment, the EPCS operation parameters transmitted to the corresponding STA need to be updated, and the non-AP MLD generates a management frame for setting up updated EPCS operation parameters with the corresponding STA, and sets up the updated EPCS operation parameters with the corresponding STA.

In one embodiment, the EPCS operation parameters transmitted to the corresponding STA need to be updated, and the non-AP MLD generates an action frame for setting up updated EPCS operation parameters with the corresponding STA, and sets up the updated EPCS operation parameters with the corresponding STA.

In one embodiment, the EPCS operation parameters transmitted to the corresponding STA need to be updated, and the non-AP MLD generates multiple sets of EPCS operation parameters for the corresponding STA, generates a message indicating which of the multiple sets of EPCS operation parameters is currently in use, and based on the message indicating which of the multiple sets of EPCS operation parameters is currently in use, sets up updated EPCS operation parameters with the corresponding STA.

The above flowcharts illustrate example methods that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An access point (AP) multi-link device (MLD) comprising:
APs, each comprising a transceiver configured to:
form a link with a corresponding station (STA) of a non-AP MLD; and
transmit information associated with emergency preparedness communication services (EPCS) operation parameters to the corresponding STA; and
a processor operably coupled to the transceiver, the processor configured to:
determine whether the EPCS operation parameters transmitted to the corresponding STA need to be updated;
when the EPCS operation parameters transmitted to the corresponding STA do not need to be updated, continue with current EPCS operation parameters; and
when the EPCS operation parameters transmitted to the corresponding STA need to be updated, determine a procedure for updating the EPCS operation parameters.

2. The AP MLD device of claim 1, wherein:
the EPCS operation parameters transmitted to the corresponding STA need to be updated, and
to determine the procedure for updating the EPCS operation parameters, the processor is configured to:
generate a teardown message for tearing down the EPCS operation parameters for the corresponding STA,
determine that the EPCS operation parameters have been torn down, and
setup updated EPCS operation parameters with the corresponding STA.

3. The AP MLD device of claim 1, wherein:
the EPCS operation parameters transmitted to the corresponding STA need to be updated,
the transceiver is configured to receive a teardown message from the corresponding STA for tearing down the EPCS operation parameters for the corresponding STA, and
to determine the procedure for updating the EPCS operation parameters, the processor is configured to:
determine that the EPCS operation parameters have been torn down, and
setup updated EPCS operation parameters with the corresponding STA.

4. The AP MLD device of claim 1, wherein:
the EPCS operation parameters transmitted to the corresponding STA need to be updated, and
to determine the procedure for updating the EPCS operation parameters, the processor is configured to:
generate a first management frame indicating that the AP MLD no longer has EPCS capability,
determine that the EPCS operation parameters have been torn down,
generate a second management frame indicating that the AP MLD again has EPCS capability, and
setup updated EPCS operation parameters with the corresponding STA.

5. The AP MLD device of claim 1, wherein:
the EPCS operation parameters transmitted to the corresponding STA need to be updated,
to determine the procedure for updating the EPCS operation parameters, the processor is configured to generate a message for updating the EPCS operation parameters of the corresponding STA, and
the transceiver is configured to transmit, unsolicited, the message for updating the EPCS operation parameters.

6. The AP MLD device of claim 5, wherein the message for updating the EPCS operation parameters comprises a frame that includes an action field.

7. The AP MLD device of claim 5, wherein the message for updating the EPCS operation parameters comprises a frame that includes a priority access multi-link element.

8. The AP MLD device of claim 5, wherein the message for updating the EPCS operation parameters comprises an EPCS priority access enable response frame that includes updated values of the EPCS operation parameters.

9. The AP MLD device of claim 1, wherein:
the EPCS operation parameters transmitted to the corresponding STA need to be updated, and
to determine the procedure for updating the EPCS operation parameters, the processor is configured to:
generate a management frame for setting up updated EPCS operation parameters with the corresponding STA, and
setup the updated EPCS operation parameters with the corresponding STA.

10. The AP MLD device of claim 1, wherein:
the EPCS operation parameters transmitted to the corresponding STA need to be updated, and
to determine the procedure for updating the EPCS operation parameters, the processor is configured to:
generate an action frame for setting up updated EPCS operation parameters with the corresponding STA, and
setup the updated EPCS operation parameters with the corresponding STA.

11. The AP MLD device of claim 1, wherein:
the EPCS operation parameters transmitted to the corresponding STA need to be updated, and
to determine the procedure for updating the EPCS operation parameters, the processor is configured to:
generate multiple sets of EPCS operation parameters for the corresponding STA,
generate a message indicating which of the multiple sets of EPCS operation parameters is currently in use; and
based on the message indicating which of the multiple sets of EPCS operation parameters is currently in use, setup updated EPCS operation parameters with the corresponding STA.

12. A non-access point (AP) multi-link device (MLD) comprising:
stations (STAs), each comprising a transceiver configured to:
form a link with a corresponding AP of an AP MLD; and
receive information associated with emergency preparedness communication services (EPCS) operation parameters from the corresponding AP; and
a processor operably coupled to the transceiver, the processor configured to:
determine whether the EPCS operation parameters received from the corresponding AP need to be updated;
when the EPCS operation parameters received from the corresponding AP do not need to be updated, continue with current EPCS operation parameters; and
when the EPCS operation parameters received from the corresponding AP need to be updated, determine a procedure for updating the EPCS operation parameters.

13. The non-AP MLD device of claim 12, wherein:
the EPCS operation parameters received from the corresponding AP need to be updated,
the transceiver is configured to receive a teardown message for tearing down the EPCS operation parameters for the corresponding AP, and
to determine the procedure for updating the EPCS operation parameters, the processor is configured to:
determine that the EPCS operation parameters have been torn down, and
setup updated EPCS operation parameters with the corresponding AP.

14. The non-AP MLD device of claim 12, wherein:
the EPCS operation parameters received from the corresponding AP need to be updated,
the transceiver is configured to transmit a teardown message to the corresponding AP for tearing down the EPCS operation parameters for the corresponding AP, and
to determine the procedure for updating the EPCS operation parameters, the processor is configured to:
determine that the EPCS operation parameters have been torn down, and
setup updated EPCS operation parameters with the corresponding AP.

15. The non-AP MLD device of claim 12, wherein:
the EPCS operation parameters received from the corresponding AP need to be updated,
the transceiver is configured to:
receive a first management frame indicating that the AP MLD no longer has EPCS capability,
receive a second management frame indicating that the AP MLD again has EPCS capability, and
to determine the procedure for updating the EPCS operation parameters, the processor is configured to:
determine that the EPCS operation parameters have been torn down, and
setup updated EPCS operation parameters with the corresponding AP.

16. The non-AP MLD device of claim 12, wherein:
the EPCS operation parameters received from the corresponding AP need to be updated,
the transceiver is configured to receive an unsolicited message for updating the EPCS operation parameters, and
to determine the procedure for updating the EPCS operation parameters, the processor is configured, based on the received unsolicited message, to update the EPCS operation parameters.

17. The non-AP MLD device of claim 16, wherein the message for updating the EPCS operation parameters comprises a frame that includes an action field.

18. The non-AP MLD device of claim 16, wherein the message for updating the EPCS operation parameters comprises a frame that includes a priority access multi-link element.

19. The non-AP MLD device of claim 16, wherein the message for updating the EPCS operation parameters comprises an EPCS priority access enable response frame that includes updated values of the EPCS operation parameters.

20. The non-AP MLD device of claim 12, wherein:
the EPCS operation parameters received from the corresponding AP need to be updated,
the transceiver is configured to receive a management frame for setting up updated EPCS operation parameters with the corresponding AP, and
to determine the procedure for updating the EPCS operation parameters, the processor is configured, based on the received management frame, to setup the updated EPCS operation parameters with the corresponding AP.

21. The non-AP MLD device of claim 12, wherein:
the EPCS operation parameters received from the corresponding AP need to be updated,
the transceiver is configured to receive an action frame for setting up updated EPCS operation parameters with the corresponding AP, and
to determine the procedure for updating the EPCS operation parameters, the processor is configured, based on the received action frame, to setup the updated EPCS operation parameters with the corresponding AP.

22. The non-AP MLD device of claim 12, wherein:
the EPCS operation parameters received from the corresponding AP need to be updated,
the transceiver is configured to:
receive multiple sets of EPCS operation parameters for the corresponding AP,
receive a message indicating which of the multiple sets of EPCS operation parameters is currently in use; and
to determine the procedure for updating the EPCS operation parameters, the processor is configured, based on the message indicating which of the multiple sets of EPCS operation parameters is currently in use, to setup updated EPCS operation parameters with the corresponding AP.

23. A method for wireless communication performed by an access point (AP) multi-link device (MLD) that includes APs, the method comprising:
forming a link with a corresponding station (STA) of a non-AP MLD;
transmitting information associated with emergency preparedness communication services (EPCS) operation parameters to the corresponding STA;
determining whether the EPCS operation parameters transmitted to the corresponding STA need to be updated;
when the EPCS operation parameters transmitted to the corresponding STA do not need to be updated, continuing with current EPCS operation parameters; and
when the EPCS operation parameters transmitted to the corresponding STA need to be updated, determining a procedure for updating the EPCS operation parameters.

24. The method of claim 23, wherein:
the EPCS operation parameters transmitted to the corresponding STA need to be updated, and
the method further comprises:
generating a teardown message for tearing down the EPCS operation parameters for the corresponding STA,
determining that the EPCS operation parameters have been torn down, and
setting up updated EPCS operation parameters with the corresponding STA.

25. The method of claim 23, wherein:
the EPCS operation parameters transmitted to the corresponding STA need to be updated, and
the method further comprises:
receiving a teardown message from the corresponding STA for tearing down the EPCS operation parameters for the corresponding STA,
determining that the EPCS operation parameters have been torn down, and
setting up updated EPCS operation parameters with the corresponding STA.

26. The method of claim 23, wherein:
the EPCS operation parameters transmitted to the corresponding STA need to be updated, and
the method further comprises;
generating a message for updating the EPCS operation parameters of the corresponding STA, and
transmitting, unsolicited, the message for updating the EPCS operation parameters.

27. The method of claim 26, wherein the message for updating the EPCS operation parameters comprises a frame that includes an action field.

28. The method of claim 26, wherein the message for updating the EPCS operation parameters comprises a frame that includes a priority access multi-link element.

29. The method of claim 26, wherein the message for updating the EPCS operation parameters comprises an EPCS priority access enable response frame that includes updated values of the EPCS operation parameters.
